(19) United States
(12) Patent Application Publication
(10) Pub. No.: US 2022/0368053 A1
(43) Pub. Date: Nov. 17, 2022

(54) TERMINAL FOR CONTACTING A CONTACT PIN

(71) Applicant: Phoenix Contact GmbH & Co. KG, Blomberg (DE)

(72) Inventor: Andre Holtkaemper, Berlin (DE)

(21) Appl. No.: 17/761,244

(22) PCT Filed: Sep. 17, 2020
(86) PCT No.: PCT/EP2020/075952

§ 371 Date: Mar. 17, 2022

(30) Foreign Application Priority Data
Sep. 19, 2019 (DE) 10 2019 125 285.7

(51) Int. Cl. H01R 13/11

(52) U.S. Cl. CPC H01R 13/11

(57) ABSTRACT

A terminal for contacting at least one contact pin includes: a socket carrier; and at least one socket, which includes in each case a first contact arm connected to the socket carrier and a second contact arm connected to the first contact arm via a resilient connection, which second contact arm is pivotable, in a space between the first contact arm and the socket carrier, between a vacant position and an occupied position. In the vacant position the second contact arm is arranged at a first distance from the socket carrier and in the occupied position the second contact arm is arranged at a second distance from the socket carrier which is smaller than the first distance. A restoring force of the resilient connection in the occupied position contacts the respective contact pin between the first contact arm and the second contact arm.

### CROSS-REFERENCE TO PRIOR APPLICATIONS

This application is a U.S. National Phase application under 35 U.S.C. § 371 of International Application No. PCT/EP2020/075952, filed on Sep. 17, 2020, and claims benefit to German Patent Application No. DE 10 2019 125 285.7, filed on Sep. 19, 2019. The International Application was published in German on Mar. 25, 2021 as WO 2021/053062 under PCT Article 21(2).

### FIELD

The invention relates to a terminal or clamp for contacting at least one contact pin. In particular, the invention relates to, but is not limited to, a corresponding terminal block.

### BACKGROUND

In existing rail-mounted terminal blocks, the individual connections, for example with a width of about 6.3 mm, comprise a double-sided spring contact (for example a tulip-type contact) as a socket or receptible. The use of such spring contacts in a terminal with narrower connections, for example with a width of about 3.5 mm, is not possible because their installation space requirement in the width direction is too large. The space requirement is too large since the double-sided spring contact is too wide just for the socket alone and, furthermore, both contact sides of the double-sided spring contact are spring-loaded.

### SUMMARY

In an embodiment, the present invention provides a terminal for contacting at least one contact pin, comprising: a socket carrier; and at least one socket, which comprises in each case a first contact arm connected to the socket carrier and a second contact arm connected to the first contact arm via a resilient connection, which second contact arm is pivotable, in a space between the first contact arm and the socket carrier, between a vacant position and an occupied position, wherein in the vacant position the second contact arm is arranged at a first distance from the socket carrier and in the occupied position the second contact arm is arranged at a second distance from the socket carrier which is smaller than the first distance, and wherein a restoring force of the resilient connection in the occupied position is configured to contact the respective contact pin between the first contact arm and the second contact arm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic perspective view of a terminal according to a first embodiment in a vacant position;

FIG. 2 shows a schematic sectional view parallel to a longitudinal direction of a terminal according to the first embodiment in a vacant position;

FIG. 3 shows a schematic side view in longitudinal direction of a terminal according to the first embodiment;

FIG. 4 shows a schematic perspective view of a terminal according to a second embodiment in an occupied position;

FIG. 5 shows a schematic sectional view parallel to a longitudinal direction of a terminal according to the second embodiment in the occupied position;

FIG. 6 shows a schematic sectional view of an exemplary socket carrier, which can preferably be combined with the first or second embodiment;

FIG. 7 shows a schematic view of an exemplary stamped part for producing a socket, preferably according to the first or second embodiment;

FIG. 8A shows a perspective view of a variant of the first or second embodiment; and

FIG. 8B shows a sectional view of the variant of the first or second embodiment.

### DETAILED DESCRIPTION

In an embodiment, the present invention provides a terminal or clamp for contacting at least one contact pin, which builds or is narrower or allows more connections in a given width, preferably without reducing a contact force for contacting the contact pin and/or without reducing a receivable pin width of the contact pin. In an embodiment, the invention provides a terminal or clamp for contacting at least one contact pin, which is capable of receiving the contact pin laterally close to an edge of the terminal or clamp.

Further features and advantages of embodiments of the invention are described below, partly with reference to the drawings.

One aspect of the invention relates to a terminal (or clamp) for contacting at least one contact pin. The terminal comprises a socket carrier (or socket support) and at least one socket (or receptacle or bushing or jack). The at least one socket comprises a respective first contact arm attached to the socket carrier and a respective second contact arm attached to the first contact arm via a resilient connection. The second contact arm is pivotally movable, in the space between the first contact arm and the socket carrier, between a vacant position (or unoccupied position) and an occupied position. In the vacant position, the second contact arm is arranged at a first distance from the socket carrier. In the occupied position, the second contact arm is arranged at a second distance from the socket carrier, which is smaller than the first distance. A resilient force of the resilient connection in the occupied position is configured for contacting the respective contact pin between the first contact arm and the second contact arm.

In embodiments, by the first contact arm being attached to the socket carrier and the second contact arm being attached to the first contact arm via the resilient connection, the second contact arm pivots from the vacant position to the occupied position under a wedge action of the contact pin inserted into the socket in the longitudinal direction, while the first contact arm remains in position relative to the socket carrier. These or further embodiments enable a terminal for contacting the at least one contact pin, which builds or is narrower or has more terminals in a given width. A contact force for contacting the contact pin and/or a receivable pin width of the contact pin may be the same as (or greater than) a larger-built double-sided spring contact, for example, in that within the resilient region of the resilient connection, a travel of the second contact arm between the vacant position and the occupied position is twice as great as a travel of a conventional contact arm. The same or further embodiments may allow the contact pin to be received laterally close to an edge of the terminal, for example by the first contact arm facing the edge of the terminal or being disposed at the edge of the terminal.

The terminal may be configured or deployable (or applicable) as a socket. For example, the terminal may be mounted or mountable on a circuit board. Alternatively or additionally, the terminal may be configured as a series terminal. For example, the terminal may comprise a row or array of sockets as terminals of the terminal block.

The socket or each of the at least one socket may be configured to receive the respective contact pin between the first contact arm and the second contact arm. Each socket may be configured to receive the respective contact pin along a longitudinal direction of the first contact arm.

The restoring force (or reset force) in the occupied position may push the second contact arm toward the first contact arm. In the occupied position, the contact (or the contacting) may comprise (or provide for) an electrical contact, and optionally a frictional contact. The restoring force may move the second contact arm from the occupied position to the vacant position in the absence of a contact pin.

The second contact arm may be exclusively attached to the first contact arm. This means that the second contact arm may be indirectly attached to the socket carrier via the first contact arm.

A stiffness of a mechanical connection between the first contact arm and the socket carrier may be greater than a stiffness of a mechanical connection between the second contact arm and the socket carrier. The mechanical connection between the first contact arm and the socket carrier may be stiff compared to the resilient connection between the second contact arm and the socket carrier.

The socket carrier may be an electrical insulator. The socket carrier may be made of a thermoplastic. The socket carrier may form a closed outer surface of the terminal. The terminal may comprise a plurality of sockets having a socket carrier that is continuously closed on the outer surface.

A distance of the first contact arm to the socket carrier in the vacant position and in the occupied position may be the same. A distance of the first contact arm to the socket carrier may be at least substantially the same in the vacant position and in the occupied position. For example, a distance traveled by the first contact arm between the vacant position and the occupied position may be a fraction (for example, less than one-tenth) of the distance traveled by the second contact arm between the vacant position and the occupied position.

A longitudinal direction of the first contact arm in the vacant position and in the occupied position may be parallel to the socket carrier.

The first contact arm may be connected to the socket carrier on one long side along the longitudinal direction.

The terminal may comprise at least two sockets. Optionally, the terminal may further comprise at least one partition wall, which is extending in the longitudinal direction between adjacent sockets and projecting from the socket carrier. The partition wall may extend parallel to the longitudinal direction adjacent a long side of the first contact arm opposite the connected long side.

The first contact arm may be attached to the socket carrier along the connected long side with a socket wall extending in the longitudinal direction and projecting from the socket carrier, for example directly connected. The socket wall may project vertically from the socket carrier. The socket wall may be arranged centrally between adjacent partition walls.

The socket wall may comprise (opposite the connected long side of the first contact arm) a mounting surface for mounting on the socket carrier. The mounting surface may extend beyond the socket in the longitudinal direction. The socket wall may be riveted using heat to the socket carrier. For example, the mounting surface may have rivet openings for hot riveting.

A height of the socket wall projecting perpendicularly from the socket carrier may determine the first distance. A diameter or width of the contact pin may determine the second distance. The second distance may be the first distance minus the diameter or width of the contact pin.

The socket wall, the first contact arm, the resilient connection and/or the second contact arm may be integrally one-piece. Alternatively or additionally, the socket wall, the first contact arm, the resilient connection and/or the second contact arm may be electrically conductive. The resilient connection may electrically conductively connect the second contact arm to the first contact arm.

One or more contact points for contacting the contact pin may be between the first contact arm and the second contact arm in the longitudinal direction at the level of the socket wall. The first contact arm and the second contact arm may contact each other at the contact point in the vacant position.

The first contact arm may have a beaded projection (or a beading that is projecting) at the contact point. The second contact arm may be curved away from the first contact arm at the contact point.

An end of the first contact arm opposite the resilient connection may extend in the longitudinal direction and/or be parallel to the socket carrier. The end of the first contact arm opposite the resilient connection may extend beyond the socket wall in the longitudinal direction and/or parallel to the socket carrier.

The resilient connection may comprise an arc at a transverse side of the first contact arm to the second contact arm. An end of the second contact arm opposite the transverse side (resiliently connected to the first contact arm, for example) may be a free end of the second contact arm. The end of the second contact arm opposite the transverse side (resiliently connected to the first contact arm) may be a free end of the pivotal movement between the vacant position and the occupied position. The free end may be movable due to or against the resilient force of the resilient connection.

A continuous connection of the socket wall along the long side of the first contact arm may be wider than the arc at the transverse side of the first contact arm.

The second contact arm may have a ramp slope or leading ramp at an end opposite the resilient connection, which is configured to be moved from the vacant position to the occupied position against the restoring force from the contact pin.

The terminal may be open on a side opposite the socket carrier and/or bounded (or covered) by the first contact arm.

The terminal may further comprise a mating surface (or interface surface) perpendicular to the socket carrier. The mating surface may include, in spatial association (or spatial relation) with each of the at least one socket, a through opening for receiving the respective contact pin. The end of the first contact arm opposite the resilient connection may be aligned in the longitudinal direction with the through opening in the mating surface for receiving the respective contact pin.

An end face of the partition wall, an end face of the mating face and/or an outer face of the first contact arm may be parallel to the socket carrier. The end face (or edge) of the partition wall, the end face (or edge) of the mating surface and/or the outside of the first contact arm (for example, with the exception of the bead at the contact point) may be flush.

The invention is explained in more detail below with reference to the drawings based on preferred embodiments.

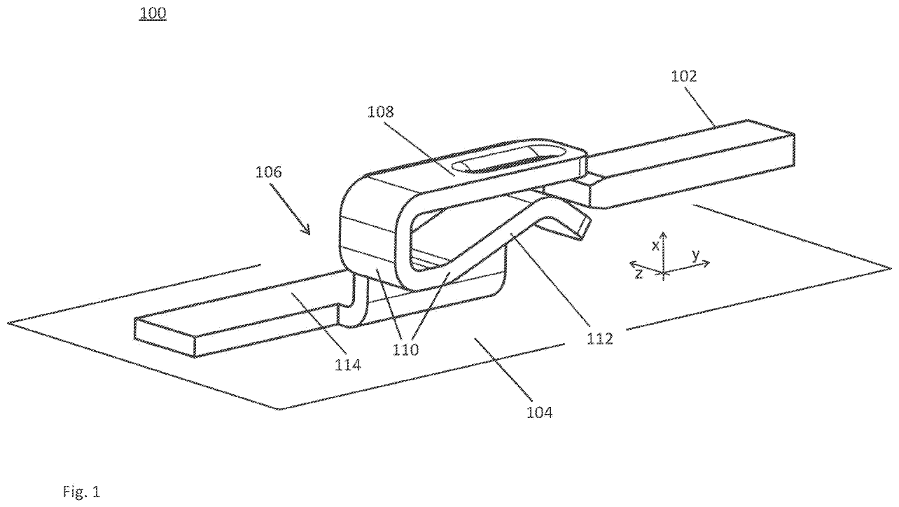

FIG. 1 shows a first embodiment of a terminal generally designated by reference numeral 100 for contacting at least one contact pin 102 (for example, a pin).

The terminal 100 comprises a socket carrier 104 and at least one socket 106 (which may also be referred to as a receptacle or a plug socket). Each of the at least one socket 106 comprises a first contact arm 108 attached to the socket carrier 104 and a second contact arm 112 attached to the first contact arm 108 via a resilient connection 110. The first contact arm may form a stiff contact side of the socket 106.

The second contact arm 112 is pivotally movable in the space between the first contact arm and the socket carrier 104, namely between a vacant position and an occupied position of the second contact arm 112. The second contact arm may form a resilient contact side of the socket 106.

In the vacant position, the second contact arm 112 is arranged at a first distance from the socket carrier 104. In the occupied position, the second contact arm 112 is arranged at a second distance from the socket carrier 104, which is smaller than the first distance. A resilient force of the resilient connection 110 in the occupied position urges the second contact arm 112 against the respective contact pin 102, and thus urges the contact pin 102 against the first contact arm 108, whereby the contact pin 102 is in contact with both sides between the first contact arm 108 and the second contact arm 112.

The first contact arm 108 is preferably attached to the socket carrier 104 along its extent (for example, its entire extent or more than half of its extent) in a longitudinal direction of the socket 106 (which is referred to as the y-direction in the first embodiment of FIG. 1), i.e., mechanically connected to the socket carrier 104.

Preferably, the mechanical connection also makes electrical contact, for example, to a conductor (preferably a conductor track or trace) on the socket carrier 104. The described mechanical connection conducts current from the contact point to the base (or foot) 114 of the socket 106. The electrical contact between the socket 106 and the conductor (for example, a conductor track or trace) may further comprise a solder connection (preferably not in a variant of an embodiment with a lead frame).

At the base 114, contact is made, for example via the solder connection, with a conductor track or trace on a printed circuit board of the socket carrier 104. The base 114 (for example, its contact surface) may be adapted to a solder geometry for the printed circuit board.

For a compact terminal 100 and/or for receiving the contact pin 102 laterally close to the edge of the terminal 100, the first contact arm 108 may be directly connected to the socket carrier 104 (for example, a rear wall of the terminal 100) as a contact side of the socket 106. As a result, the first contact arm 108 may be stiff, for example several times stiffer than the second contact arm 112. By being connected to the first contact arm 108 via the resilient connection 110, the second contact arm 112 may be resiliently pivotable. The second contact arm 112 generates a contact force (more precisely: contact normal force) required for contacting in the occupied position of the socket 106, i.e., in the plugged state of the contact pin 102.

While embodiments describe the resilient connection 110 as a separate portion of the socket 106, the resilient connection 110 and the second contact arm 112 may also jointly provide the spring resilience. For example, the second contact arm 112 may be a flat-form spring.

The mechanical connection may comprise a base 114, for example, as shown in FIG. 1. The base 114 may be attached to the socket carrier 104 in a surface or point (i.e., spot) manner. For example, the base 114 of the socket 106 may be adhesively (preferably glued) attached to the socket carrier 104. Alternatively or additionally, the base 114 may include through recesses through which the base 114 is riveted to the socket carrier 104. Alternatively, mounting pins (for example, thermoplastic mounting pins) may be formed on the socket carrier 104 and crimped or welded into the through recesses of the base 114.

The base 114 may serve to secure the socket 106, and preferably to conduct current, to the socket 106. Optionally, the geometry of the base 114, particularly the end of the base 114, may be formed into a shape adapted for soldering (for example, for connection to the printed circuit board), or may be shaped according to the application.

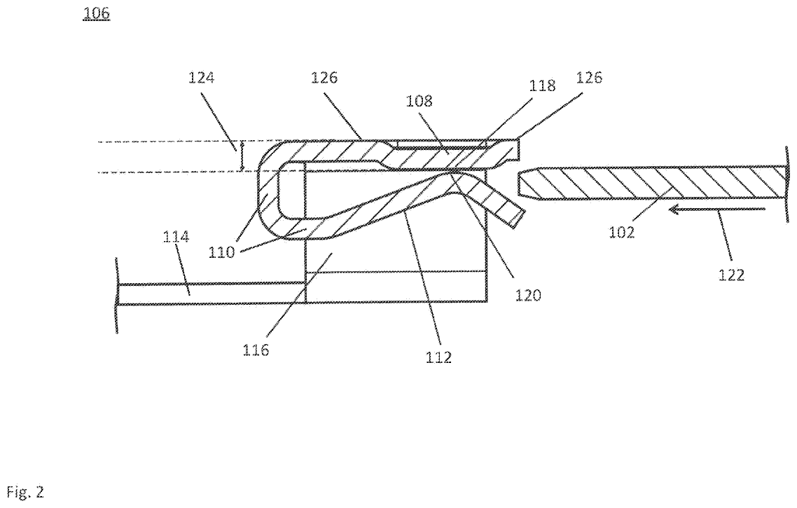

FIG. 2 shows a schematic sectional view parallel to the longitudinal direction of the terminal 100 according to the first embodiment in the vacant position.

A direct connection 116, such as the socket wall, between the first contact arm 108 (i.e., the stiff contact side of the socket 106) and the socket carrier 104 achieves stiffness of the first contact arm 108, for example, by shaping the socket 106 such that the first contact arm 108 is directly connected to the socket carrier 104 of the terminal 100 along its entire length (in the y-direction). Preferably, the direct connection 116 of the first contact arm 108 comprises a small lever arm relative to contact points 118 and 120 of the contact arms 108 and 112, respectively.

In one variation of each embodiment, the contact points 118 and 120 may contact each other in the vacant position. In another variation, the contact points 118 and 120 may be spaced apart in the vacant position.

In the occupied position (for example, in both variations), one of the contact points 118 and 120 may each rest pressed against opposite sides of the contact pin 102 by the restoring force.

The contact point 118 on the first contact arm 108 may comprise a bead in the first contact arm 108. The contact point 120 on the second contact arm 112 may comprise a bend in the second contact arm 112 that curves away from the first contact arm 108.

By implementing the contact point 118 of the first contact arm 108 (i.e., the stiff contact side), for example, by a bead, the design space requirement 124 (i.e., the required design width) may be small, for example, compared to a bent or buckled contact arm.

In addition, the electrical current conducted through the socket 106 may be conducted (or conducted away) by means of the direct connection 116. Preferably, the mechanical attachment of the socket 106, the rigidity of a contact side of the socket 106 to the first contact arm 108, and the conduction of current to the socket 106 (i.e., from the base 114 to the contact arms) are fulfilled by means of the direct connection 116, i.e., by means of the same structural element.

The stiffness of the first contact arm 108 ensures that the contact pin 102, which is freely movable within certain limits in the transverse direction (i.e., the width direction or x-direction), is aligned with the contact point 118 of the first contact arm 108 during a plug-in operation 122 of the contact pin 102, and only the second contact arm 112 swings out during the plug-in operation 122 (i.e., swings from the vacant position to the occupied position) by bending the resilient connection 110 of the socket 106. As a result, an installation space requirement 124 of the socket 106 between an edge 126 of the terminal 100 and the contact point 118 on the first contact arm 108 (or an outer edge of the contact pin 102) may be reduced compared to conventional terminals. For example, a package space requirement 124 may correspond to a thickness of the first contact arm 108, including a bead at the contact point 118 of the first contact arm 108, if applicable.

The terminal 100 is preferably open on the side of the first contact arm 108. The first contact arm 108 may limit or cover the corresponding side of the socket 106.

Furthermore, even if the socket 106 is not ideally aligned with a contact pin 102 that is laterally clamped, for example, not freely movable transversely to the longitudinal direction (i.e., in the x-direction), it is ensured that the edge 126 of the terminal 100 or a space limit or space requirement 124 is not exceeded at the open side of the terminal 100, since during the transition from the vacant position to the occupied (or clamped) position, the first contact arm 108 (i.e., the stiff side of the socket 106) does not bend or bends only negligibly (for example in the direction of the open side of the terminal 100).

A path or travel (i.e., a spring path or spring travel) of the second contact arm 112 (for example, the flat-form spring) when the contact pin 102 is mated 122 is configured such that the second contact arm 112 swings out (for example, away from the open terminal side) in the direction of the non-critical installation space.

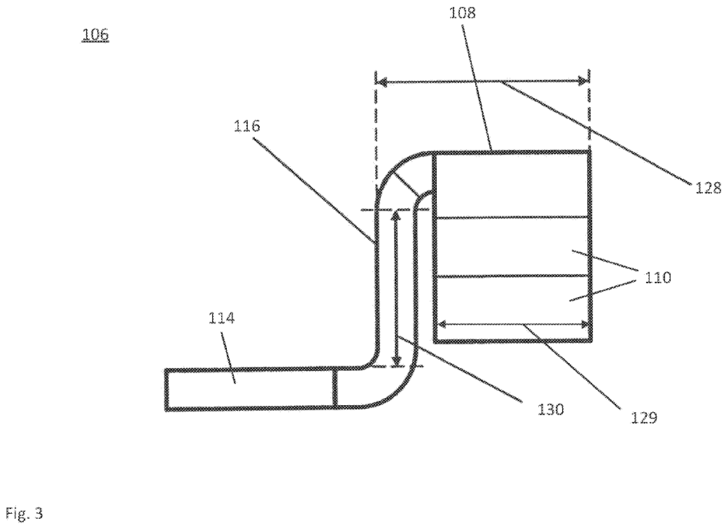

FIG. 3 schematically shows a side view looking in the longitudinal direction of the terminal 100 according to the first embodiment. The direct connection 116 with a small lever arm from the first contact arm 108 (more precisely: the contact point 118) to the attachment point at the base 114 in the terminal 100 achieves a rigid contact support at the first contact arm 108.

The restoring force (i.e., the contact force) in the occupied position of the socket 106 (i.e. in the plugged state of the contact pin 102) may be determined by a material thickness, a first depth 128 (for example, an extension in the z-direction including the resilient connection 110 and the direct connection 116), a second depth 129 (for example, an extension in the z-direction of the resilient connection 110), and/or a length (for example, an extension in the longitudinal direction or y-direction) of the resilient connection 110 and/or the second contact arm 112 (for example, the flat-form spring).

Preferably, the depth 128 or 129 of the resilient connection 110 and/or the second contact arm 112 (for example, the flat-form spring) is variable, for example, the depth 128 or 129 changes along the length of the resilient connection 110 and/or the second contact arm 112 (for example, along the flat-form spring). For example, to mechanically form the flat-form spring 110-112 to withstand stress, its depth 128 or 129 may increase from the contact point 120 to the fixed constraint on the first contact arm 108. The contact force (preferably the contact normal force or a nominal contact normal force) may be in the range of 1 N to 7 N, preferably from 2 N to 6 N.

The shallower depth 128 of the design is further advantageous for insulation requirements, for example near an open side of the terminal 100.

As exemplified based on the first embodiment in FIGS. 1 to 3, embodiments of the terminal 100 allow for a very small installation space requirement 124 of the socket 106 in the region of the relevant width direction. This is true in the vacant position (i.e., in the unmated or unplugged state) and also in the occupied position (i.e., in the plugged state), and optionally considering a non-aligned contact pin 102.

A height 130 of the direct connection 116, for example the height 130 between the base 114 as a mounting support and the first contact arm 108, may be determined by the shape of the socket 106, for example a corresponding stamped part.

The terminal 100 may comprise a plurality of jacks 106 attached side-by-side to the same socket carrier 104.

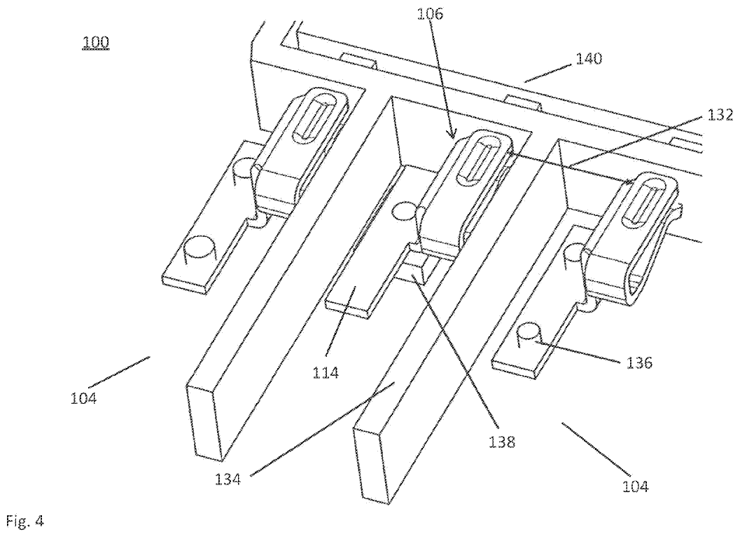

FIG. 4 shows a schematic perspective view of a terminal 100 according to a second embodiment in an occupied position. The second embodiment may further form some or all of the first embodiment. For example, some or all of the jacks 106 in the second embodiment may include some or all of the features of the first embodiment. Interchangeable or matching features of the embodiments are indicated by the same reference numerals.

Further, between adjacent receptacles 106 there are requirements for air gaps and/or creepage distances between adjacent receptacles 106. Embodiments (for example, the second embodiment) may satisfy requirements for insulation, air gaps, and/or creepage distances in a more compact manner. For example, the socket 106 may allow these requirements to be met more easily because the socket 106 requires little installation space near the open terminal side in the z-direction, and the larger installation space required (for example, to secure the socket 106 by means of the base 114 in the terminal 100) is shifted to the lower region, i.e., near the socket carrier 104 (for example, the rear wall of the terminal). For example, an increase in a spacing 132 between the first contact arms 108 of adjacent jacks 106 is achievable due to the reduced overall depth 128 compared to conventional jacks (for example, due to a shallow overall depth 128 according to the invention). The increased spacing 132 is advantageous for meeting air gap and creepage distance requirements, as shown schematically in FIGS. 3 and 4, for example. Optionally, the clearances and/or creepage distances are further increased by partition walls 134 between adjacent sockets 106.

The base 114 of each socket 106 may be secured by mounting pins 136 of the socket carrier 104. The mounting pins 136 may engage through recesses of the base 114 and frictionally connect (for example, by swaging the mounting pins 136) or positively connect (for example, by hot riveting the mounting pins 136) the base 114 to the socket carrier 104.

Alternatively or additionally, some or all of the jacks 106 may be secured to a pedestal 138 of the socket carrier 104. The mounting of the socket 106 in the terminal 100 may be directly on the socket carrier 104 (for example, on the rear wall of the terminal) or on an elevation (for example, the pedestal 138). Elevated mounting requires less material for the socket 106. The attachment may also be made to the pedestal 138 by hot riveting.

The plurality of contact pins 102 may each be inserted and contacted in a separate socket 106. The plurality of contact pins 102 may be terminals of a relay 140.

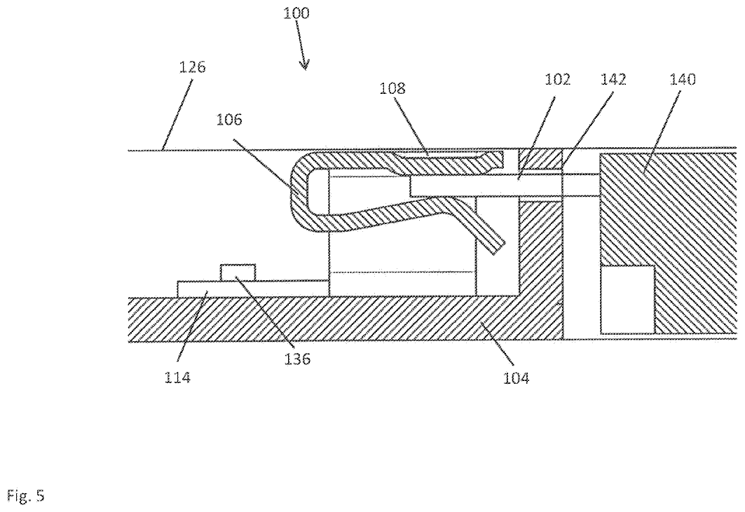

FIG. 5 shows a schematic sectional view parallel to the longitudinal direction of the terminal 100 according to the second embodiment in an occupied position. For example, the relay 140 is plugged. Each contact pin 102 is receivable in a respective through opening 142, which is laterally close to the edge 126, during the plugging operation 122.

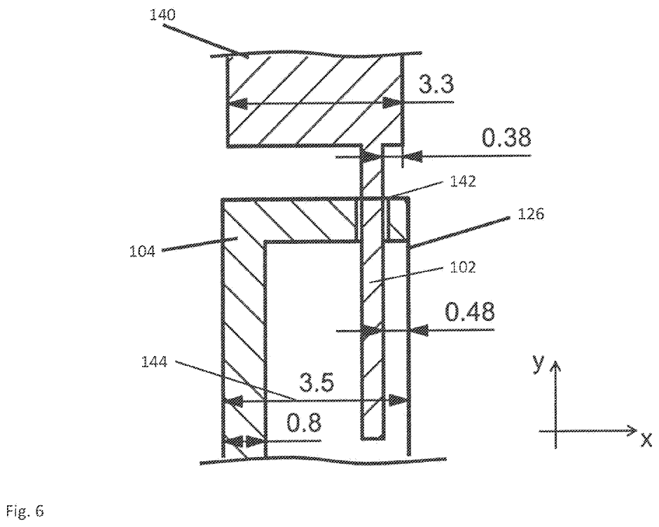

FIG. 6 shows only exemplary dimensions (in millimeters, with decimal places separated by a dot) in a schematic sectional view of an exemplary socket carrier 104, which may be combinable with the first or second embodiment. The advantages described in connection with FIG. 6 may also be achievable with other dimensions (for example, as a relative change from a respective conventional terminal to be improved).

Embodiments of the terminal 100, preferably the second embodiment, may implement a terminal block with a build width or design width 144 (for example, reduced compared to conventional terminal blocks), for example, of 3.5 mm. The reduced or small overall width 144 may be achieved, among other things, by opening one side of the terminal (for example, at the edge 126). Embodiments of the terminal 100, preferably the second embodiment, may realize terminals of the reduced or small width 144 for pluggable relays 140. By means of the compact sockets 106, the contact pins 102 of the relay 140 may be plugged into a terminal block, for example of the width of 3.5 mm, while respecting the available installation space.

It is still possible to arrange a plurality of terminals with plugged relays. A cranking of the contact pins 102 (for example relay pins) is avoided.

The relay 140 typically has pins, i.e., contact pins 102, that lie in a width direction (referred to herein as the x-direction) near one of the side relay housing walls, for example, 0.38 mm and/or as shown in FIG. 6.

With a relay 140 of a width of about 3.3 mm, this results in a relay arrangement in the terminal 100 in which the pins 102 are close to the open terminal side 126. An arrangement of the relay 140 rotated by 180° about the y-axis is not feasible, since the pins 102 would then lie too close to or in the terminal rear wall 104.

By means of the compact socket 106 of the terminal 100 with a very narrow design in the width direction, for example, an installation space of approx. 0.48 mm and/or as shown in FIG. 6 is made possible. Even with the pin 102 plugged, and taking into account the tolerances, the socket 106 preferably does not protrude beyond the installation space, i.e., the edge 126, of the terminal 100, for example on the open side.

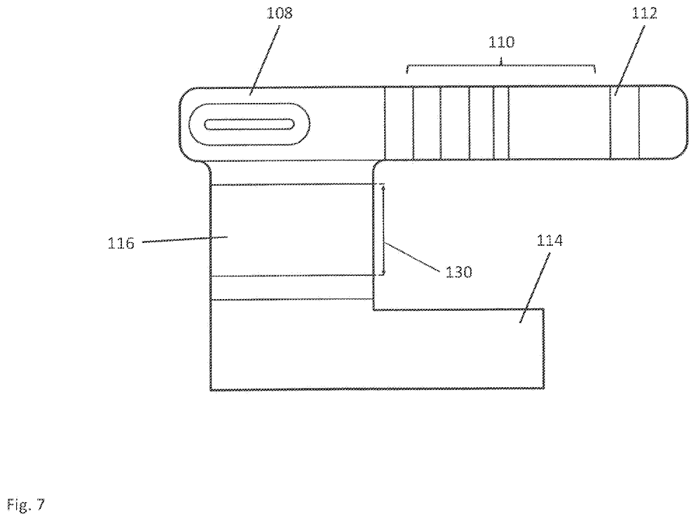

FIG. 7 shows a schematic view of an exemplary stamped part for producing the socket 106, for example, according to the first or second embodiment of the terminal 100.

The socket 106 may be manufactured as a stamp-bent part. In one embodiment, the stamp-bend part of the socket 106 or a plurality of sockets 106 may be stamped as part of a lead frame (i.e., a support strip or connection frame). Optionally, the lead frame may not only be used for fabrication or manufacturing, but may also be used (for example, along with other structural elements on the lead frame) directly in the terminal 100.

Advantageously, the socket 106 may be designed as part of the lead frame, since, for example, there is no welding or the like, for example, only as a bent part.

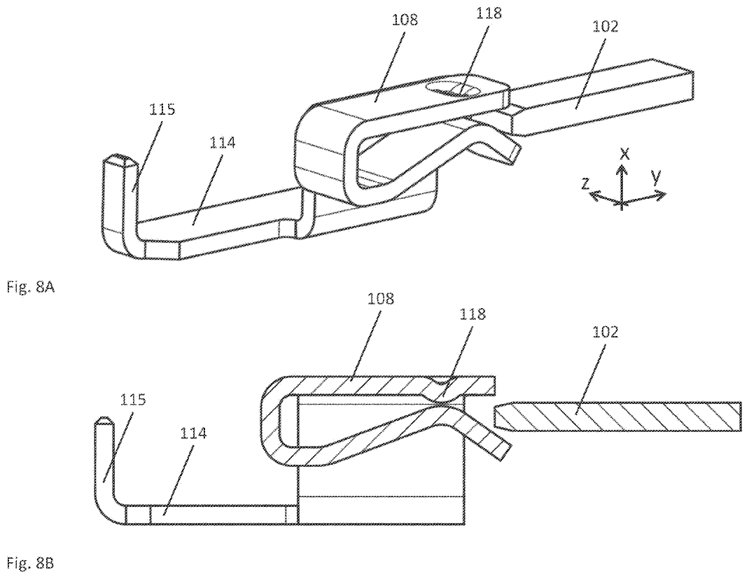

FIG. 8A and FIG. 8B show another embodiment of the terminal 100, for example a variant of the first or second embodiment of the terminal 100, in a perspective view or sectional view, respectively. The base 114 comprises a solder pin 115, for example for soldering to a printed circuit board or to a conductor.

Alternatively or additionally, the bead at the contact point 118 of the first contact arm 108 may be larger transversely (preferably perpendicularly) to the longitudinal direction (i.e., in the z-direction) than in the longitudinal direction (i.e., in the y-direction).

As shown based on exemplary embodiments above, embodiments of the terminal may be more compact in design. In addition, the second contact arm (for example, the flat-form spring) may be protected by the first contact arm (i.e., the stiff contact side) from impermissible plastic deformation, for example, during handling of the open terminal.

In any embodiment, an optional support (i.e., stop) of the second contact arm (for example, the flat-form spring) may allow for a buckling spring characteristic during the mating process.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Terminal 100
Contact pin 102
Socket carrier of the terminal, preferably rear wall of the terminal 104
Terminal socket 106
First contact arm of socket 108
Resilient connection of the socket 110
Second contact arm of socket 112
Socket base 114
Solder pin 115
Direct connection between first contact arm and socket carrier, preferably socket wall 116
Contact point on first contact arm 118
Contact point on second contact arm 120
Plugging process 122
Installation space requirement 124
Edge of the terminal 126
First depth of connections 128
Second depth of resilient connection or second contact arm 129
Height of the direct connection 130
Distance between contact arms of adjacent sockets 132
Partition walls between adjacent sockets 134
Mounting pins of the socket carrier 136
Pedestal 138
Relay 140
Through hole 142
Width 144

1. A terminal for contacting at least one contact pin, comprising:
a socket carrier; and
at least one socket, which comprises in each case a first contact arm connected to the socket carrier and a second contact arm connected to the first contact arm via a resilient connection, which second contact arm is pivotable, in a space between the first contact arm and the socket carrier, between a vacant position and an occupied position,
wherein in the vacant position the second contact arm is arranged at a first distance from the socket carrier and in the occupied position the second contact arm is arranged at a second distance from the socket carrier which is smaller than the first distance, and
wherein a restoring force of the resilient connection in the occupied position is configured to contact the respective contact pin between the first contact arm and the second contact arm.

2. The terminal of claim 1, wherein a distance of the first contact arm from the socket carrier is equal in the vacant position and in the occupied position.

3. The terminal of claim 1, wherein a longitudinal direction of the first contact arm is parallel to the socket carrier in the vacant position and in the occupied position.

4. The terminal of claim 3, wherein the first contact arm is connected to the socket carrier at a long side along the longitudinal direction.

5. The terminal of claim 3, wherein the at least one socket comprises at least two sockets, and
wherein the terminal further comprises at least one longitudinally extending partition wall between adjacent sockets projecting from the socket carrier.

6. The terminal of claim 5, wherein the partition wall extends parallel to the longitudinal direction adjacent a long side of the first contact arm, which long side is opposite a connected long side.

7. The terminal of claim 4, wherein the first contact arm is attached to the socket carrier along a connected long side with a socket wall extending in the longitudinal direction and projecting from the socket carrier.

8. The terminal of claim 7, wherein a contact point configured to contact the contact pin between the first contact arm and the second contact arm in the longitudinal direction is level with the socket wall.

9. The terminal of claim 8, wherein the first contact arm includes a beaded protrusion at the contact point.

10. The terminal of claim 8, wherein the second contact arm is curved away from the first contact arm at the contact point.

11. The terminal of claim 7, wherein an end of the first contact arm opposite the resilient connection extends in the longitudinal direction and/or is parallel to the socket carrier.

12. The terminal of claim 11, wherein the end of the first contact arm opposite the resilient connection protrudes beyond the socket wall in the longitudinal direction and/or parallel to the socket carrier.

13. The terminal of claim 7, wherein the resilient connection comprises an arc at a transverse side of the first contact arm to the second contact arm.

14. The terminal of claim 13, wherein a continuous connection of the socket wall along the long side of the first contact arm is wider than an arc at the transverse side of the first contact arm.

15. The terminal of claim 1, wherein the second contact arm has, at an end opposite the resilient connection, a leading ramp configured to be moved from the vacant position to the occupied position against the restoring force by the contact pin.

16. The terminal of claim 1, wherein the terminal is open on a side opposite the socket carrier and/or is bounded by the first contact arm.
